(19) United States
(12) Patent Application Publication
(10) Pub. No.: US 2013/0169237 A1
(43) Pub. Date: Jul. 4, 2013

(54) Battery cathode depolarization circuit

(71) Applicant: Edward Milton McWhorter, Citrus Heights, CA (US)

(72) Inventor: Edward Milton McWhorter, Citrus Heights, CA (US)

(21) Appl. No.: 13/374,540

(22) Filed: Jan. 3, 2012

(51) Int. Cl. H02J 7/00

(52) U.S. Cl. 320/137

(57) ABSTRACT

An electrical depolarization circuit is used to shorten the charging time of secondary cells by transferring a portion of the battery electrode cathode polarization charge into an ionic capacitor stream comprised of a gaseous ionic mixture of lower oxidative potential flowing within a tubular circuit passing through the battery electrolyte.

### CROSS REFERENCES

Ref. 1 U.S. application Ser. No. 12/378,425 Rapid Charge Transportation Battery. Filed Feb. 17, 2009.
Ref. 2 U.S. Pat. 6,831,825 Fuel Cell Ionic Capacitor. Application Ser. No. 10/457,702. Filed Jun. 10, 2003.
Ref.3 U.S. Pat. No. 8,071,041 Potassium Electric Generator and Chemical Synthesizer. Application No. 12/005,093. Filed Dec. 26, 2007.

### CLAIM OF PRIORITY

The present application is a continuation-in-part of Ref. 1.

### BACKGROUND OF THE INVENTION

The invention is a storage battery comprised of a plurality of rechargeable secondary cells having their anode and cathode electrodes interconnected by three types of electrical conductor circuits. The metal electrodes are connected in electrical series by class-1 wire conductors. The metal electrodes being immersed in an electrolyte are also interconnected by electrolytic class-2 conduction through the liquid medium while exchanges of oxidation reactions are alternately occurring during battery discharging and charging periods.

During charging a reverse current is forced through the cells of the battery which transposes the chemical oxidation reactions produced at the cells electrode surfaces which during discharging are transformed back to their reduced state during charging. Heat is generated during the charging period and this heat is accumulative and can damage the battery during charging if not kept in check. The rate at which the heat is accumulated is exponentially equivalent to the square of the charging current and directly proportional to the electrolyte electrical resistance (Q=I²R). When the charging rate is to rapid the water molecules in the electrolyte begin to boil and form gaseous steam at the surface of the electrodes. During the charging period the battery cells no longer operate as galvanic cells, the reverse charging current has converted the cells to electrolytic cells which are capable of dissociating the thermally stressed steam vapor water molecules into their component parts as hydrogen positrons (H⁺) and negative charged hydroxyl (OH⁻) ions and a free electron (H²O→H⁺+e⁻+OH⁻). The gaseous hydrogen positron (H⁺) bubbles produced fill the inflated volume of the dissociated steam molecules. The like-on-like positive repelling force of the hydrogen bubble charge filling the steam volume inhibit the negative charged electron flow through the gaseous hydrogen volume resulting in increased resistance through the polarized field surrounding the electrode and thereby preventing further electrode reduction actions to proceed during the charging period.

During the charging period the reversing current passes through a class-1 conductor and the circuit is completed by class-2 liquid conduction through the electrolyte which results in the accumulation of positrons (H⁺) at the electrode and subsequent polarization. A third type circuit comprised of a class-2 gaseous conductor is required to carry away the polarization charge. The third circuit is an ionic capacitor circuit described in Ref. 2 which is immersed in the battery electrolyte. The class-2 gaseous conductor fluid passing through the ionic capacitor is at a lower oxidation potential than the polarized positron (H⁺) fields surrounding the electrodes. The cell metal electrodes are in electrical contact with the ionic capacitor outer shell and form a class-1 conductor circuit between the polarization field and the lower oxidative potential of the gaseous flow within the ionic capacitor circuit which carry the excessive polarization charge out of the battery. The oxidative flow through ionic capacitor is produced by the method described in Ref. 3.

### SUMMARY OF THE INVENTION

It is an object of the invention to lower the internal electrical resistance of storage batteries during periods of heavy discharge and during periods of high charging rate by transferring excessive hydrogen polarization charge at the battery electrode surfaces into an ionic capacitor.

It is another object of the invention to decrease the ratio of battery downtime relative to the battery useful operative discharging period by increasing the current flow during the battery charging period.

It is yet another object of the invention to increase electrical vehicle operating range by charging the vehicle batteries at a rapid charging rate while the vehicle is in motion.

It is yet another object of the invention to increase the charging rate of transportation batteries while simultaneously reducing the heating rate and accumulated heat during the charging period.

### DRAWINGS

Six drawings are presented to illustrate how the depolarization circuit is connected internally to the cell electrode circuits within the battery.

FIG. 1 is a frontal view of the battery cathode electrode.

FIG. 2 is a side view of the battery cathode electrode shown in cross-section.

FIG. 3 is an end view and corresponding side view of the depolarization circuit insulator.

FIG. 4 is a cross-sectional view of the depolarization circuit insulator.

FIG. 5 is a cross-sectional view of the assembled depolarization circuit.

FIG. 6 is a diagrammatic illustration of the assembled components of the depolarization circuit assembly immersed within the battery cell electrolyte.

### DETAILED DESCRIPTION OF THE INVENTION

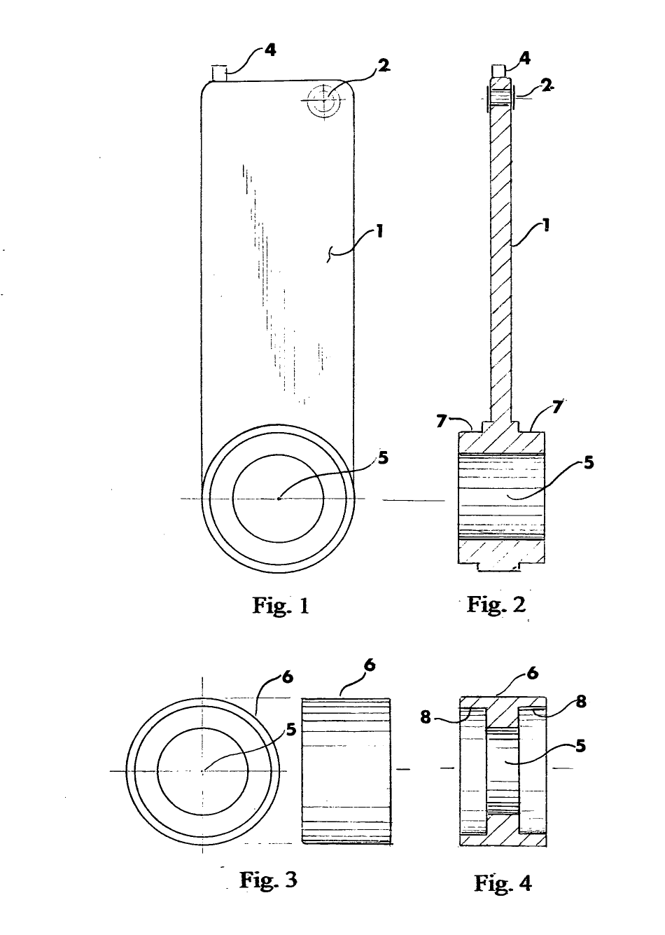

FIG. 1 is a frontal view of cathode 1. Cathode 1 is a metal cathode electrode. The type of metal used to construct cathode 1 determines the galvanic output of the assembled cell relative to the comparative oxidation states of selected anodes paired with cathode 1 metals immersed within a given battery electrolyte media.

The cathode 1 of FIG. 1 has a small hole 2 in the upper right hand corner for passage of an insulative supporting rod to steady the upper portion of cathode 1 within the cell compartment. A metal connector 4 is positioned in the upper left corner of cathode 1. Tubular metal conduit 5 is a short circular protruding passage formed at the lower end of cathode 1.

FIG. 2 is a side view of FIG. 1 shown in cross-section. Metal conduit 5 forms a cylindrical tubular passageway for the gaseous flow of a positive charged ionic class-2 conductor. The positive charged ionic class-2 conductor fluid is in electrical contact with the inner cylindrical surfaces of metal conduit 5. The outer cylindrical surfaces of metal conduit 5 forming notch 7, are in electrical contact with the higher oxidative potential of electrode 1 hydrogen polarization field surrounding electrode 1 which is immersed in the battery electrolyte. The hydrogen polarization field is at a higher oxidation potential than the positive charged ionic class-2 conductor stream flowing through metal conduit 5 and therefore transfers a portion of its polarization charge into the positive ion stream. The process of transferring the polarization charge through notch 7 outer surface into the inner surface of conduit 5 forms the novelty of the ionic capacitor described in Ref. 2. The said positive ionic flow through conduit 5 is described in Ref. 3.

Turning now to FIG. 3 which is an end view and corresponding side view of the depolarizer circuit insulator 6 which is positioned between cell cathodes 1. The purpose of the insulator 6 is to prevent class-1 electrical metal connection between cell cathodes such that electrical conduction between cells within the depolarization circuit is only by class-2 conduction within the positive ion stream.

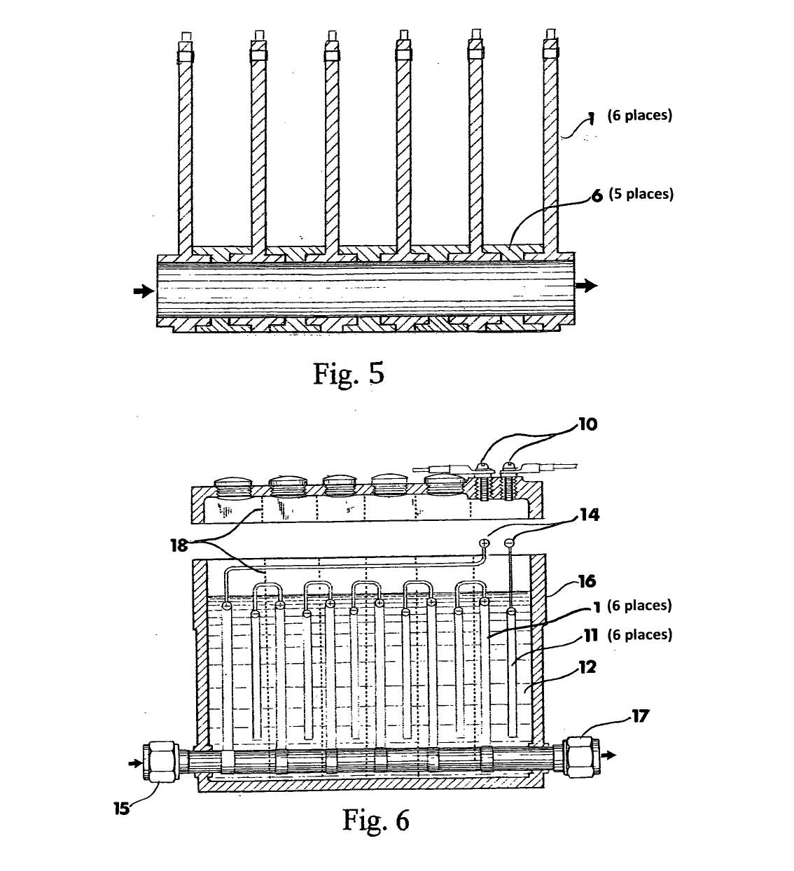

FIG. 4 is a cross-section of insulator 6. Notch 8 interlocks with notch 7 of cathode 1 to form the depolarization circuit shown in FIG. 5. FIG. 5 is a cross-section of the assembled depolarization circuit comprised of alternating interconnecting cathode 1 and insulators 6. The depolarization circuit of FIG. 5 is comprised of six cathode 1 separated and interconnected by 5 insulators 6.

FIG. 6 is a diagrammatic illustration of the assembled components of a depolarization circuit installed in a series wired battery circuit 14. Connector 10 is the attachment points of the battery external load circuit. Anode 11 is positioned opposite the cathode 1 immersed in electrolyte 12. The cathode 1 and anode 11 forming the individual cells of the battery and occupy their individual cell compartments diagrammatically indicated by broken lines 18. The depolarization circuit of FIG. 5 is shown passing through battery case 16. The positive ionic flow enters the polarization circuit at inlet 15 and exits the depolarization circuit at outlet 17.

### DRAWING ELEMENTS

1. cathode
2. hole
3. - - -
4. terminal
5. cylinder
6. insulator
7. notch
8. notch
9. - - -
10. connector
11. anode
12. electrolyte
13. - - -
14. series terminal
15. Inlet gas flow
16. battery case
17. outlet gas flow
18. cell compartment boundaries

What is claimed is:

1. A battery cathode depolarization circuit for decreasing the charging time of secondary cells by partial absorption of the electrical charge of hydrogen positron (H⁺) bubbles forming at the surface of the cathode during charging and transferring the absorbed charge into an ionic capacitor within the depolarization circuit immersed within the cell electrolyte which in turn partially removes the absorbed positron (H⁺) charge from the cell by transferring it into a class-2 conductor positive ion gaseous circuit of lower oxidative potential exiting the battery through the depolarization circuit.

2. Claim 1 in which the class-2 conductor positive ion gaseous circuit is a class-2 positive ion circuit.
